(19) United States
(12) Patent Application Publication
(10) Pub. No.: US 2014/0046963 A1
(43) Pub. Date: Feb. 13, 2014

(54) Dynamic Search Processor

(71) Applicant: Robert D. Fish, Tustin, CA (US)

(72) Inventor: Robert D. Fish, Tustin, CA (US)

(21) Appl. No.: 14/061,642

(22) Filed: Oct. 23, 2013

Related U.S. Application Data
(62) Division of application No. 11/166,926, filed on Jun. 23, 2005, now abandoned.
(60) Provisional application No. 60/593,034, filed on Jul. 30, 2004.
(60) Provisional application No. 60/583,294, filed on Jun. 25, 2004.

(51) Int. Cl. G06F 17/30

(52) U.S. Cl. CPC G06F 17/30699
USPC 707/748; 707/754

(57) ABSTRACT

The present invention provides systems and methods in which user-created and user-selectable personas are used to enhance a search string for submission to a search engine. The persona information can also be used to filter or rank search results. A given user can combine multiple characteristics in various ways to produce different persona, and can choose among different as desired for a given search. Software to capture, maintain, store, and use persona information can be physically spread out across multiple computers operated by different companies, with a third party hosting the persona capturing interfaces.

This application is a divisional of U.S. patent application Ser. No. 11/166,926, filed on Jun. 23, 2005, which claims priority to U.S. Provisional Application No. 60/593,034 filed Jul. 30, 2004 and U.S. Provisional Application No. 60/585,294 filed Jun. 25, 2004.

### FIELD OF THE INVENTION

The field of the invention is information searching.

### BACKGROUND

A critical problem in searching modern information databases, whether they are proprietary databases such as LEXIS™ or Westlaw∩, or public access databases such as Yahoo™ or Google™, is that a search often yields far too much data for anyone to realistically review. The problem can be resolved to some extent by careful selection of keywords, and sometimes by filtering by date or other criteria. But even narrow searches can often still yield many more records that a user can realistically review. Moreover, addition of ever more limiting key words in the search string often results in the user missing records that would be of significant interest. In short, the presently commercialized methods of keyword searching are both inherently over-inclusive and under-inclusive.

In an earlier series of patents and applications (see U.S. Pat. Nos. 6,035,294, 6,195,652, and 6,243,699). one of the inventors of the present invention outlined a database system that seeks to resolve these problems by standardizing the storing of data. These and ail other referenced patents, applications, web pages, and other resources are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

The key in the U.S. Pat. Nos. 6,035,294, 6,195,652, and 6,243,699 is to characterize information of all types by parameter/value pairs, and allow both parameters and values to evolve over time according to aggregate usage. In a practical embodiment a user loading information onto the system is presented with listings of parameters and values that are sorted by frequency of usage. Parameters and values that experience high usage float to the top of the list while parameters and values that experience low usage sink to the bottom, and are eventually discarded. Upon retrieval, a user is also presented with frequency, sorted listings of parameters and related values. The system then delivers the results set in a table that shows all of the information the person wants, and none of fee information that the searcher considers to be noise. Unfortunately, such strategies are primarily beneficial for adding new information to a conforming database, and retrieving information from that database. They are of much less useful in sorting through the billions of pages of non-conforming data in existing web pages or other records.

With respect to nonconforming databases, there are conceptually only a handful of ways of limiting the search results. The most common strategies are: (1) altering the search criteria, (2) limiting the record set; and (3) ranking (sorting) the results. The past decade has seen advances in each of those strategies.

### Prior Art Directed to Limiting the Search Criteria

Yahoo™ led the way in Internet searching for many years, allowing users to perform keyword searches using any reasonable number of search terms. Users were even allowed to combine keywords using complex Boolean algebra.

Systems have now advanced to where users can limit searches using non-keyword limitations as well. Yahoo™, for example, allows users to employ the non-keyword limitations of date of last update, domain (.com, .gov, .org, etc), file format (PowerPoint, Word, text, etc), maturity level (filtering out adult materials), and language (English, German, Japanese, etc.). Google™ allows user to employ still other non-keyword limitations, including number of occurrences of the search terms within the target records, and location of the search terms within the record (e.g. title, text, URL, links, etc). Unfortunately, it is still commonplace for a search to return a record set comprising millions of records, far more that anyone could reasonably peruse.

There have also been efforts to append search criteria in a more or less background mode, i.e. without the user specifically adding limitations to the search string. In. U.S. Pat. No. 6,381,594 to Eichstaedt et al, (April 2002), the search engine creates a user-profile from a user's prior searches, and uses that profile as an aid to filtering future searches. The system is directed to users that perform repetitive (“persistent”) searches, such as wanting to know all new products within a price range, weather in a given locale, updates on a particular company, etc. Unfortunately, the system has little or no value for users that desire to perform different searches on different subject matters. The last thing a typical user wants is to have his searches for “great barrier reef” filtered by his previous searches for Los Angeles weather.

### Prior Art Directed To Limiting The Record Set

Other systems have tried to address the problem by limiting the records in the database according to their content. For example, there are currently specialized search engines for specific religious groups (Christian, Muslim, etc), and these sites market themselves as having access to only a limited subset of existing sites. There are other search engines directed to record sets limited woodworking, crafts, sports and so forth.

The main search engines have also jumped on that bandwagon. Almost every popular search engine allows users to search a reduced record set limited to broad topics (jobs, movies, health, business, science, computers, humanities, news, recreation, and so forth). But those sets are only useful if they happen to match the searcher's particular interests at the time, and they tend to be extremely broad. For example, there don't appear to be any major search engines listing etymology as a topic.

None of this is sufficient. A recent Google™ search for computer memory cards retrieved 5,170,000 records. The same search for the specific string “computer memory cards” retrieved 29,200 records, while the same search under the computers group still retrieved 1,150 records. That last record set was clearly under-inclusive, yet it contained way too many records to be useful.

### Prior Art Directed To Ranking The Record Set

Given that the search engines are very poor at providing a realistic number of results, the focus has more recently been on ranking the resulting record set according to the apparent value of the data. For example, a search engine searching for “chocolate cake” would typically rank records having the word combination “chocolate cake” higher than records in which both words are present, but separated from one another.

Another popular way of ranking is to use apparent popularity of the records. The Ask Jeeves™ search engine, for example, lists the categories of most frequent searches, and allows users to peruse the most frequently accessed records in those categories. In practice, the system is of limited value. A recent list provided the following top ten categories, music lyrics; online dictionary; maps; games; weather; driving directions; jokes; food; free ring tones; and baby names. Obviously, the term “frequency” in that context is merely a way of identifying the lowest common denominator among the searching public, and has little benefit for a great many searchers.

Another way of ranking records is to use the average length of time that users spend viewing any given record (or web page in the case of the Internet). Several search engines rank search results according to an algorithm that includes average viewing time. In that manner the sites deemed to be of most value to most people would tend to be sorted to the top of the list. Unfortunately, there are still problems. On problem is that time spent on a web page doesn't necessarily correlate with value of that web page. It may well be that a given web page is loaded with data that is entirely extraneous to the search, but is interesting nonetheless, and tends to keep users focused on the page. It may also be that the web page includes links to other, far more useful sites, but keeps users pinned to the host site by linking to the other sites without leaving the host site. Still further, the fact that a web site is of great interest to “most people” may have nothing whatever to do with the value of the information on the site, or with the value to a given searcher.

### Focusing On The Individual Searcher

One possible solution is to record demographics for a given searcher, and then limit or rank the search results according to those demographies. Thus, if a searcher is a 25 year old single male, the search engine could be configured to provide search results that reflect preferences of 25 year old single male. That approach to filtering records, of course, is the flip side of the coin of so-called behaviorally targeted advertising. There, an Internet provider compiles data on Web visitors, such as their surfing history, gender, age and personal preferences, and uses that information to subsequently target them with tailored ads. The idea was hyped during the Internet heyday as the promise of a one-to-one medium, but failed to deliver because of technology limitations and privacy concerns.

But there is a deeper problem as well. The interests and preferences of an individual may have nothing whatever to do with his age, marital status, gender, or other demographies. A single young male may well be searching the Internet for “superbowl” because he wants to purchase a very large bowl for cooking. A seventy five year old woman may well be interested in purchasing jogging shorts, if only to give-as a present for a relative.

A more sophisticated search strategy focuses not so much on what the general public does, but what specialized groups are doing. For example, Eurekster™ keeps track of how long a searcher stays on a web page, and then restricts future search results by an algorithm that tries to extrapolate preferences from the searchers past behavior. Eurekster™ then allows individual searchers to create a social network (or join into a previous social network), which ranks future searches by members of the network according to what others in the network have already done. The system is intriguing, but ultimately still not satisfactory. For one thing, the system only works well if a subsequent searcher in the network enters the same search as a previous searcher. That may work for very broad searches, such as “Ronald Reagan”, or “weapons of mass destruction”, but not for detailed searches such as “red yeast rice and statins”. In addition, the system works very poorly if the network is very small, very large, or very diverse. Eurekster™ has almost, no advantage for very small social networks because there is very likely little or no history for the search, and would tend to provide only minimal filtering for large or diverse networks.

In addition, the reality of human beings is that they wear many faces in the world (multiple persona). A given individual may relate to one group of friends according to his age and gender, but relate to another group of friends by his hobbies or career. Social network search engines may well give terrible results for a high school junior whose main interest is pre-med programs, but whose friends are all focused on college basketball. The fact that Joe is Pete's jogging buddy may mean that the two of them share preferences when it comes to athletics, but it doesn't in any way mean that they share his religious or political views or interests.

The interface at http://www.noodletools.com/index.html does allow a user to select whether he/she is (a) a kid; (b) pretty new to the Internet; or (e) an Internet wizard. Those are characteristics of a user, but are characteristics that do not change very often, and certainly would not change from search to search. Moreover, the Noodle interface is not a search engine, but merely a signpost to direct a user to an appropriate search engine.

U.S. Pat. No. 6,671,682 to Nolte et al. (December 2003) teaches creation and uses of multiple personas as an aid to conducting on-line searches. That patent, however, only contemplates true personas, not fictional personas. That limitation is inherent throughout the disclosure, and is expressly required by basing the various personas around a core persona. In FIG. 3, for example, the '682 patent shows a core persona that includes a 14 year old female, and three-personas, each of which inherit the age and gender characteristics from the core persona. Thus, a given user could not have one identity as a male, and another identity as a female because those two are inconsistent. But it is contemplated that users can want to have personas that are inconsistent with their identity, and are inconsistent with any core persona to the extent that a core persona exists. Thus, what is needed is a search system that filters search results according to characteristics of the user, where those characteristics can be combined together into multiple persona, and modified or selected at will without regard to the users true identity and without regard to other personas for the same person.

In addition, the '682 patent only uses the persona information for filtering results returned by the search engine. It doesn't use that information to create or modify the search string. What are still needed are systems and methods in which persona information is used to semantically or otherwise enhance a search string for submission to a search engine.

### SUMMARY OF THE INVENTION

The present invention provides systems and methods in which user-created and user-selectable personas are used to enhance a search string for submission to a search engine. The persona information can also be used to filter or rank search results.

A persona includes one or more characteristics, which can, for example, include user goals, interests, setting/context and descriptors. Such characteristics can be obtained by user specification, algorithmic manipulation of personas, and/or user historical monitoring. Characteristics can range from standard demographic information such as gender, age, and race, to hobbies, business, or religious interests, to the goals of a search activity.

A key feature of preferred embodiments that a given user can alter his persona as desired for a given search, without necessarily conforming to reality or to other personas for the same user. Thus, a persona can be fictional. For one search a user might take on the persona of a single mother; for another search, the same user might take on the persona of a married male rock climber.

Systems and methods currently contemplated to be of especial value would allow users to combine 2, 3, 4, 5 or more user characteristics together to create different personas. The set of possible characteristics can be presented to a user in any suitable format, but are preferably presented as a drop-down or other listing in which the choices can be ordered by frequency of use, alphabetically, or in some other useful manner. Users or programs can add new kinds of persona attributes to the set of possible characteristics. In especially preferred embodiments a user can designate the relative importance of different ones of the user characteristics. Still further, embodiments are contemplated in which a user can alter one or more of his personas over time, with characteristics being added, removed, and/or modified.

Personas can also evolve over time more or less automatically, using data mining techniques on historical user behavioral data, including for example securing the active assistance of users in designating usefulness of web sites or other information records. Usefulness can be recorded using any suitable paradigm, from a simple yes/no dichotomy to a range or other more complex paradigms and metrics. Persona evolution can also be enhanced by analysis of user behavior, past searches, and other historical data. Furthermore, the capability can exist to algorithmically manipulate personas using additional knowledge about the user and/or information domain.

Personas can be stored in a database independent of individual web sites, which database can be centralized or distributed. Access can be given to summary-level information from the persona database to deliver sponsored messages or advertisements tailored to the interests and demographics of persona groups or categories. Individual user identity information is private, unless the user specifies otherwise.

Search engines (which are interpreted herein to include functional equivalents) can provide the interfaces for capturing personas directly from users on a voluntary basis.

Alternatively, information relating to the personas can be obtained indirectly from a third party service provider. Thus, for example, software to capture, maintain, store, and use persona information, or for any of the other functions described herein, can be physically distributed over multiple computers operated by different companies, with for example a third party hosting the interfaces for capturing persona information. In addition, the tem “software” is to be interpreted broadly, including any number of programs or other code, and including code that is not within the same commercial “package”.

Still another aspect of the subject matter includes a persona knowledge system in which persona attributes, and their underlying conceptual translations, are stored and hierarchically interrelated. The invention can extract information and relationships from this knowledge system to: create personas; improve existing personas; offer suggestions to users for refining personas, and translate personas into concepts for automatic search enhancement.

### Semantically Enhanced Searching

In yet another aspect of the subject matter, persona searching can be combined with expanded search terms. While persona searching addresses the problem of over-inclusiveness in the search results, the use of expanded search addresses the problem of under-inclusiveness. It is especially contemplated that search terms can be expanded semantically (i.e. conceptually), which term is defined herein to mean expansion that goes beyond mere synonym, number, and generality expansions.

Some forms of automated enhanced searching/are already in fairly common usage. For example, several search engines automatically expand search terms by number, to include their regular plurals. Thus, a search for “desk AND lamp” will be expanded as “(desk OR desks) AND (lamp OR lamps). More sophisticated versions of number expansion will expand using regular plurals, such as “women” when one is searching for “woman.” Another relatively common expansion is by synonym. Thus, a search for “elephant” will automatically be expanded to “elephant OR pachyderm”. Still another relatively common expansion is by generality. In that case a search for “elephant” can automatically be expanded to “elephant OR large mammal.” Semantically searching goes beyond all of these techniques.

Semantic searching modifies a given string conceptually based upon a knowledge system. Inputs into the knowledge system include the user's search siring, and can also include additional information that may or may not be captured in a persona. Such information can include a user's intention in performing a search; goals and desired outcomes of a search; predilections toward certain subjects, concepts and ideas, and demographic, environmental and hardware information. More abstract user preferences could also be used such as: types of data should be included; information format and display (computer monitors, PDAs, cellular telephone screens, etc.); restrictions on sourcing; level of detail, and generality. Concrete and abstract user information is selectively integrated into queries, and not arbitrarily applied to all searches.

As mentioned above, enhanced searching can operate independently of personas, and vice versa. However, it is specifically contemplated herein to provide systems and methods in which information is extracted from personas and used to semantically enhance existing searches, which in turn intends to increase user satisfaction with search engine results.

Information derived from persona characteristics are preferably fused with search terms to the expanded search terms injunctively (i.e. by using AND connectors rather than the disjunctive OR connectors). Concepts extracted from personas can in turn have deep, complex syntactical formatting (using both AND and OR connectors). The following table provides examples.

| | | Semantic Expanded Search String Incorporating |
|---|---|---|
| Basic Term | Persona | Persona |
| Computer | Bargain hunter | Computer memory AND (“mark down” OR |
| memory | | bargain OR sale) |
| Headache | Interested in | Headache AND (Los Angeles) AND (“drug trial” |
| | local drug trials | OR (drug NEAR trial) OR “clinical trial”) |
| Mortgage rates | Franchise | Mortgage rates AND franchise AND (investment |
| | investor | OR investor OR portfolio) |
| Caribbean trips | Luxury traveler | Caribbean trips AND (“first class” OR “luxury” |
| | | OR “four star” OR “five star”) |
| New action film | Indie film | New action film AND ((indic OR independent) |
| | watcher | AND (“in release” OR “released”) |
| Latest News | Mobile browser | “latest news” AND (finance OR “financial news”) |
| | interested in | |
| | finance | |
| Confucius | Film Producer, | Confucius AND (book OR novel) AND (price OR |
| | Book buyer, | purchase) AND (fiction OR fantasy) |
| | escapist | |

Contemplated business models include search engines providing the interfaces for capturing personas directly from the users, and/or obtaining information relating to the personas indirectly from a third party service provider. Thus, for example, software to capture, maintain, store, and use persona information can be physically spread out across multiple computers operated by different companies, with a third party hosting the persona capturing interfaces. In such instances the third patty provider can earn income from various search engine providers in any suitable way, such as by click-throughs, advertising revenue, or in some other manner. The persona information, along with search, strategies and results, can also be sold for marketing purposes.

### BRIEF DESCRIPTION OF THE DRAWING

FIG. 1A is a Venn diagram of a searching strategy using personas.

FIG. 1B is a Venn diagram of a searching strategy using personas, showing subsets of source record sets.

FIG. 2A is an layout of a sample interface for selecting user characteristics for a persona.

FIG. 2B is another example of the sample interface of FIG. 2A.

FIG. 3 is a layout of a sample search engine interface for choosing an optional persona service.

FIG. 4A is a diagram of an interface for managing personas.

FIG. 4B is a diagram of the components, involved in software creating the enhanced search string and returning results to the user.

FIG. 5 is a diagram of the software accessing a persona through multiple web sites.

FIG. 6 is a diagram that illustrates that a user can add, manage and delete a persona through the interface.

FIG. 7 is a diagram that illustrates that a user can save a persona through the interface.

FIG. 8 is a diagram of the interface through which a user can edit any of the persona characteristics.

FIG. 9 is a diagram that shows that the software uses information about the user to create the enhanced search string.

FIG. 10 is a diagram of the software using a knowledge system in enhancing a persona and enhancing the search string.

FIG. 11 is a drawing of the knowledge system comprising persona attributes.

FIG. 12 is a web page from a link identified by a search engine to a hypothetical search, showing a like/dislike icon.

### DETAILED DESCRIPTION

Persona Searching

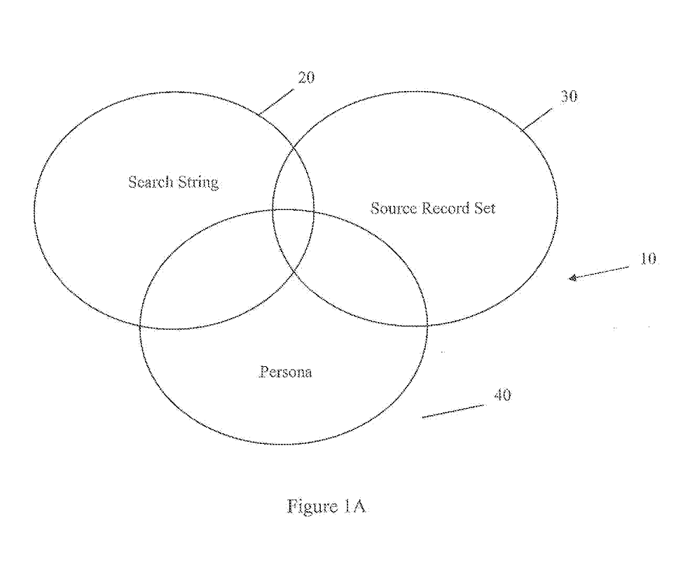

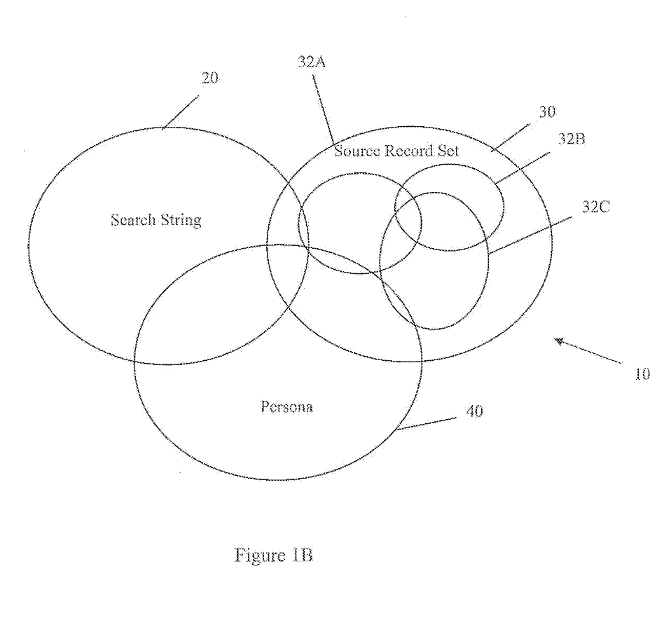

In FIG. 1A a Venn diagram 10 depicts three overlapping sets: search string 20, source record set 30, and persona 40. The intersection of the three sets 20, 30, 40 depicts a result set provided to a user.

FIG. 1B is similar to FIG. 1A, but shows that source record set 30 includes subsets 32A, 32B, 32C depicting different topics, such as business, computers, humanities, news recreation, and so forth.

### Example No. 1

A specific example will help distinguish the current idea from the prior art. Let's assume that a search engine indexes 500,000,000 web pages. Let's further assume that there are 1000 different choices for persona characteristics in 20 different areas, covering gender (male, female); age (pre-teen, tween, teen, young adult, adult, senior), and marital status (married, unmarried, previously married), employment (unemployed, out of the market, blue collar, professional, sports, etc.); educational status (student, non-student; educational level (grade, junior college, college, graduate); consumer status (looking to buy; looking to sell, browsing, not interested in buying or selling, etc), and so forth.

As each user that conducts his searches using a persona, the search engine keeps track of the web pages visited by the user for any significant period of time (e.g. at least 10 seconds), and adds to the counter for each of that person's choices. Thus, if a user utilized a persona that consisted of single, college attending, male, and visited sites twelve different sites for a period of at least ten seconds each, then the index counters for each of those twelve, sites would be updated by one for each of the three characteristics, (single, college attending, and male). Of course, the search engine also updates the counters for millions of other users.

Now another user comes along, and uses the word “mother” as her persona. She enters search term keywords, which in this example are toys, electronic, Fischer-Price. The search engine conducts the search of its database in the normal manner for the keywords, and returns in the case of Google™ would return 137,000 records from the millions of possible records. Normally the records would be sorted according to Google's proprietary sorting scheme, but using the persona search the search engine would sort the records according the counter for the characteristic, mother, and presents the ranked pointers to the user in the ranked order. In that manner the person using the “mother” persona would get to see all 137,000 records, but ranked to be useful for a person associating herself with the “mother” characteristic for the purpose of this search.

Note that this is very different from any of the search engine strategies that limit the record set according to special interests. For example, a search using the popular Christian search engine at www.goshen.net returned zero records for the same keywords (toys, electronic, Fischer-Price). The result set is also quite different from that which would be returned by an Ask Jeeves™ type of search engine using simple popularity of the web pages. In that case the system might still return the 137,000 records, but they would be sorted by popularity among all users, not those relating to the “mother” persona. This is also very different from that produced by a Eurekster™ type strategy that restricts future search results by an algorithm that extrapolates preferences from the searchers past behavior. Under the preferred paradigms of the present invention, the result set would be substantially the same whether the user had previously searched for housing, vacation spots, or even for toys. Under a Eurekster™ type strategy the results set would be very different depending on prior searching.

### Example No. 2

In a second example, a searcher (which by the way can be the same person as in example number 1), chooses a persona of a college attending father. He performs a search using the same keywords as above, namely “toys, electronic, Fischer-Price”, That searcher's result set would still consist of the same 137,000 records, but would almost certainly be sorted differently from the result set provided to the person characterizing herself merely as “mother”. The difference in sorting is because people who previously characterized themselves as “mother” would tend to stay longer on different web pages than those characterizing, themselves using college-attending father as their persona.

Returning to the discussion of FIGS. 1A, 1B, it should now be apparent that three circles are needed to describe persona based searches. One circle is needed to represent the universe of possible records 20, another circle to represent the search string (usually keywords) 30, and another independent circle is needed to represent the persona 40 adopted by the searcher for the purpose of the search.

That is not, however, to exclude the use of other strategies in addition to persona searching. For example, it is contemplated, that a user could additionally choose to limit his/her searches according to some other subset, such as entertainment, or business, or “safe” (non-adult materials). Those and any other record set limitations are depicted as smaller subsets 22A, 22B and 22C of record set 20. Dotted lines are used to depict those subsets since they are optional.

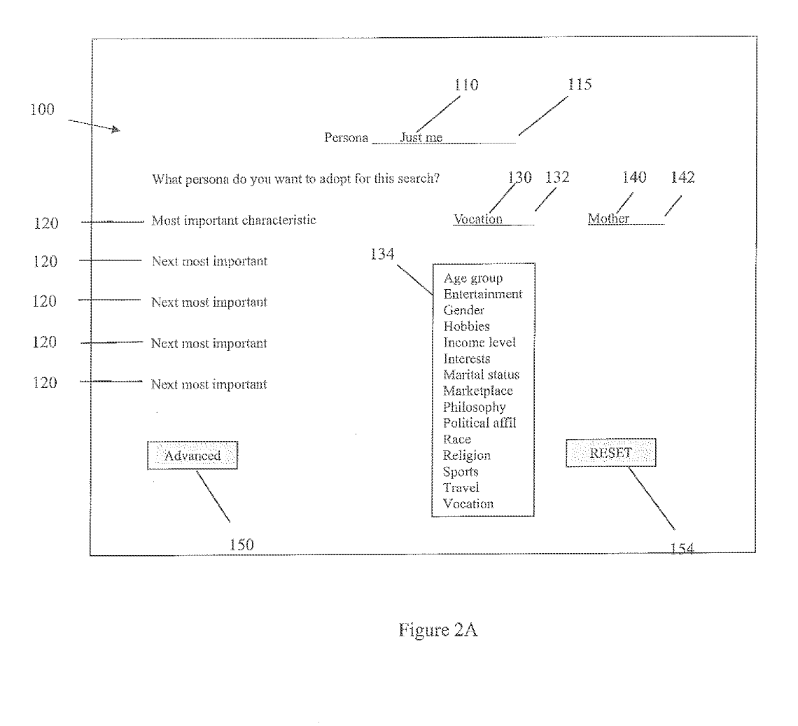

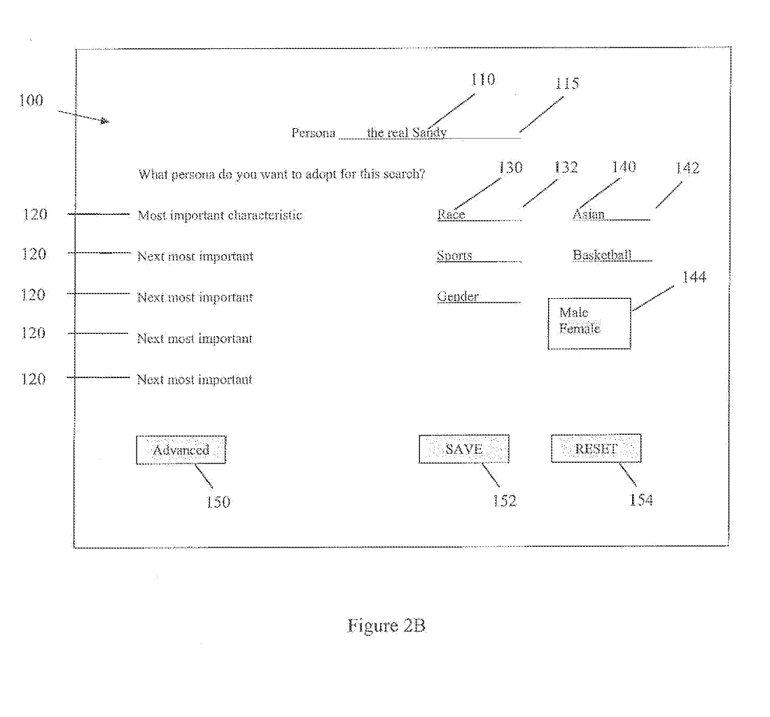

In FIG. 2A, an interface 100 suitable for a typical computer display has a field 110 in which a user can select from a prior persona, or add a new persona name. In this ease the user has added or selected the name “Just me” from the drop down box 115. Interface 100 also has five other rows 120, in each of which the user can select from different characteristics 130, and can select a choice (value) 140 for the chosen characteristic. To assist in the process the interface 100 has additional drop-down boxes 132, 142, respectively. In the particular case of shown, the user selected only the single area of “Vocation”, and selected the characteristic of “mother”. In the row for the second preference the user has not yet selected a preference, but has opened the drop down box 132 to show a listing 134 of characteristics.

Those skilled in the art will appreciate that the characteristics can be prioritized as shown, and that the priority could be used as part of the ranking formula. For example, web pages could be weighted by the sum of 1.4 times the counter for Asian viewers, 1.2 times the counter for female viewers, and 1.0 times the counter for basketball viewers. Of course, there are an infinite number of other formulas that could be adopted, and it is even contemplated that advanced user's could select the relative importance of the various characteristics, such as by giving them a number from 1 to 100. The weighting, and perhaps other option can be controlled by setting values using the “Advanced” button 150. There are other buttons as well for saving the record 152 and resetting the record 154.

In FIG. 2B, the same user has a different persona, which she identifies as “the real Sandy.” Here, she choose to use multiple characteristics of (1) Asian, (2) interested in basketball, and (3) female. The user has chosen a third characteristic of gender in the third, row, and opened, the drop down box 142 to reveal a listing of choices 144 for the gender characteristic.

It should now be appreciated that preferred embodiments of persona searching free a searcher from slavishly relying on his/her actual demographics, or upon characteristics that someone else (such, as a search engine operator) has assigned to the searcher, or indeed upon any history at all. A searcher (also referred the herein as a user), which should be interpreted herein as an ordinary human being, as opposed to a programmer or a searching “bot”, can advantageously alter his/her persona at will, without going to the effort of adopting a different identity, such as might be done by using a different sign on name or email address.

In yet other embodiments it is contemplated that the characteristics and/or the choices for the characteristic could evolve over time. For example, it may be that a user decides that part of the persona by which he wants to characterize himself involves a new characteristic called “Type, of info”. In that case the system can be setup-so that the user enters “Type of info” in one of the characteristics fields, and provisionally at least the system can add that new characteristic to the list. Now, realistically there would probably be some determination by a system manager or other person as to whether that new characteristic would be propagated to become available to others. Otherwise the system could bog down very quickly with non-sense and ill-conceived characteristics. By it is contemplated that over time users could add or at least suggest new characteristics.

The same is true of choices for the characteristics. It might be, for example, that the characteristic “Sports” list 25 different sports, but omits “archery”. A user could add or at least suggest adding archly as a type of sport, to be shown to future users.

It is still further contemplated that the lists for either or both of characteristics and choices could be presented to the user in some manner other than alphabetical. One possible listing of particular interest is some sort of ranking based upon usage. Thus, if a great deal more people choose a Sports characteristic of football over archery, then the football choice can be made to appear closer to the top of the list than the archery choice. It might even be interesting to show relative percentages, or other indicators of usage.

One of the characteristics that could be adopted is a trusted person or source. Thus, user might have as part of a persona, a great admiration far a particular sports figure, politician, movie star or other popular figure, or some organization such as the American Medical Society, or the electrical engineering society, IEEE. The filtering/ranking that might be accomplished as a result of that selection would then not so much be the preferences of the trusted person, but the preferences of others who identify themselves as trusting that particular person.

As a point of clarification, the terms filter and filtering should be interpreted herein to include ranking (sorting) of records, unless the context indicates otherwise. This is proper because in presenting large record sets they are effectively the same thing. A recent study by search engine marketing company, Enquiro™, found that if no relevant listings were found on the first page of a results set, only 20% of the participants went to the second page rather than launching a new search. If relevant sites were found on the first page, only about 5% of the participants took the time to also check listings on the second (and third) page of results. Since a user typically only looks, at the first 10 or 15 records, pushing a select group of records to the top of the list is effectively almost the same thing as limiting the presented record set to those 15 records.

### Example No. 3

As a further example to demonstrate some of the inventive concepts, it is contemplated that a searcher might be a female medical doctor, aged 35, who is a single parent with three toddlers. The woman may have just arrived at a rental condo in Carmel, Calif., with no rental car. She might engage in one or more of the following:

Characterize herself by Gender= mother, Marketplace=consumer, and conduct a search for the keywords “baby aspirin”,

Characterize herself by Vocation=physician, and conduct a search for “thiamine deficiency” for her new book.

Characterize herself by Age Group=“thirtysomething”, marital status=single, and conduct a search for “Carmel entertainment”.

Characterize herself by Age Group=toddler, Hobbies=swimming, and conduct a search for “Carmel beaches”,

Characterize herself by Interests=pets, Travel=vacation, and conduct a search for “hotels kids dogs”.

Characterize herself by Marketplace=cell phone customer, and conduct a search for “Adventures of Sinbad”.

This last example is instructive in that the presently contemplated systems and methods do not strictly limit the search of web pages to those readily usable by cell phone, PDA, etc. Aspects of that strategy are already being done (albeit not based upon selectable personas) by a new search engine recently announced by Siemens™, http://www.pcworld,idg.com.au/index .php/id;560223244;fp;2;.fpid;1. One of the many distinguishing benefits of the presently contemplated systems and methods is that the choice of what is or is not appropriate for cell phone usage will be determined by actual usage, not by fiat of some web site analyst. The sites that will tend to be sorted to the top of the list will be those that are viewed most often by people characterizing themselves as cell phone customers, and will evolve over time. Thus, “cell phone friendly” web sites that are in reality not very useful will tend to sink to the bottom of the list, while those that are useful to such users, whether or not they are considered cell phone friendly, will tend to rise to the top of the list. The user has the best of all worlds.

### Example No. 4

As a further example, consider a middle-aged person searching for a walker for his elderly father. A simple search on Google™ for the term “walker” produces 11,200,000 results. The search result set is obviously intractable, and includes a huge number of completely irrelevant links. The search result set includes, for example, almost 18,000 links dealing with the walking of house pets. A search for “elderly walker” narrows the result to 8,820, but still doesn't provide a particularly useful record set. The first listing is an article about homelessness, and happens to include the name of one Cleo Walker. Using persona searching a user would likely characterize him or herself as a middle aged person, with relation to the marketplace being a consumer. A search using that persona would likely produce a much more useful search for “elderly walkers”.

It should now be apparent that a persona search is not the same thing as a special interest search, even though the wording may be similar. For example, in a persona search a user may well identify him or herself using the characteristic, Interests-finance. If that user conducts a search using the keywords (corporate bond spread), he will almost certainly obtain a different result set from a person using the same keywords in a specialty finance focused database. A major reason is that in the persona search the user may turn up an article about a sailing competition written by a corporate bond trader. That record would presumably turn up in the persona search because it contained the relevant keywords, and tended to be viewed by people who identified themselves as being interested in finance. But that same record would very likely not turn, up on the search of the specialty finance database because the article really has very little to do with finance.

### Example No. 5

Amazon.com, and other web sites make “buying suggestions” based upon a user's buying history of books, tapes and so forth. For example, the system can suggest other teen fantasy books to users who previously purchased Harry Potter novels. On the surface those suggestions seem to overlap with some of the inventive concepts described herein. One could consider a persona to include a characteristic of Interest=teen fantasy, or even Interest=Harry Potter. But the similarity ends there because buying suggestions are based upon the user's actual buying history. If the user decides to delete or otherwise change that history, he can't. If a user decides to have one persona one day and another persona another day, he can't do that either, without changing his identity (such as by logging on with a different user ID). Moreover, all of those limitations are consequences of the fact that a user cannot select his persona at will.

### Example No. 6

Persona based searching does not, however, exclude other forms of targeted searching. For example, persona based searching could be combined with some aspects of buying suggestions as discussed above, or perhaps profile based advertising, in which marketers pay to have their URLs appear high up in a fisting based upon specific keywords. Such combinations would basically just alter the formula for ranking, and possibly add additional records that would not otherwise be included.

Persona based searching could also be combined with other pay-for-performance searching, such as that recently popularized by Teoma™. That service is a hybrid of Google™'s service and profile-based advertising, in which marketers bid against each other to improve their ranking. Once again, this is just a matter of altering the formula for ranking away from a strict frequency-based system, and possibly adding additional records that would not otherwise be included. The same is true for Audience Match™, which draws on profiles of Web surfers. The profiles, culled from online publishers, are then used to tailor ads to visitors' behaviors and demographics, or what's called behavioral targeting. In the end. those are ail simply methods of ranking, and are compatible with many embodiments of persona based searching.

In terms of business models, persona based searching could earn monies in any number of different ways. In one contemplated method, the persona technology is licensed to a search engine provider, and operated solely by that provider for its own benefit. In a preferred method, the persona technology is operated by a third party (besides the search engine provider and the searcher) as a click-through option on the search engine's web page. Once the third party obtains the persona, information relating to that persona is transmitted back to the search engine to conduct the search, or for further processing. In either event, the search engine can keep track of revenue from click-throughs and other events from that particular search, and share that revenue with the third party.

One benefit of having a third party operate the interface for creating and maintaining personas is that the same personas could be utilized by a user across the various different search engines that he/she uses. That saves time and effort, as will, immediately be recognized by Internet users who frequently find themselves entering the same information over and over again when accessing different websites.

Still other advantages of having a third party operate the personas interface include the ability of the third party to keep track of the search engines and search strategies used by individual persons. None of the major free search engines do that, and it is often very frustrating for users to become interrupted, or for other reasons lose track of their search strategies. Third party tracking of the search engines and search strategies also makes it very easy for users to port interesting search strategies from one search engine to another. Still further, the information stored by such third patties can be quite valuable to marketers, who are very interested in the characteristics of those searching for particular products, information, and so forth, and are quite willing to pay for useful statistics. Of course, the characteristics utilized in creating the personas are selected at will by the users, and are therefore not necessarily reflective of the “true” characteristics of the users. But even there we perceive potential value. The third, party can readily keep track of inconsistent designations, such as a single user having personas with vastly different age groupings. That type of information is probably also valuable to some, marketers.

It is also contemplated mat some portion: of the software (either resident on a users machine, resident, elsewhere, operated by the third party, or some combination of those) can be used to correlate search strings provided by the user with the persona(s) utilized with respect to those strings. Such information can he farther aggregated, across multiple users, and used for marketing purposes. For example, it would be no surprise that users employing personas of athletic women run searches on electrolyte sports drinks and jogging shoes, but it may turn out that many of their searches focus on anti-pronation arch supports in the shoes. That information would be very helpful to marketers both in their on-line and in their traditional marketing approaches. It may also develop that users employing an athletic woman persona tend to run a fair number of searches directed to vitamins for children. That information would also be very useful for marketers.

Having appreciated these benefits, the present inventors contemplate that such information can be sold and/or used to develop or target advertisements. In a simple example, an advertiser for athletic shoes may work with Yahoo!™ or Google™ to display sponsored ads that highlight anti-pronation shoes whenever a user submits a search relating to athletic shoes using a persona of athletic woman. In perhaps a more surprising example, the advertiser may also want to work with the search engine (which term is used herein to include the search engine provider) to display sponsored ads regarding children's vitamins when a user submits a search relating to athletic shoes using a persona of athletic woman. Thus, it is contemplated that one could correlate personas with searches performed using those personas, and aggregate those correlations over time. Such information is useful both for multiple instances of personas and searches for an individual user and across multiple individuals, and such information can be provided to others (manufacturers, marketers, search engine operators, etc) for marketing purposes. Aggregating and providing such information can be viewed as a method of doing business, and also as a software function.

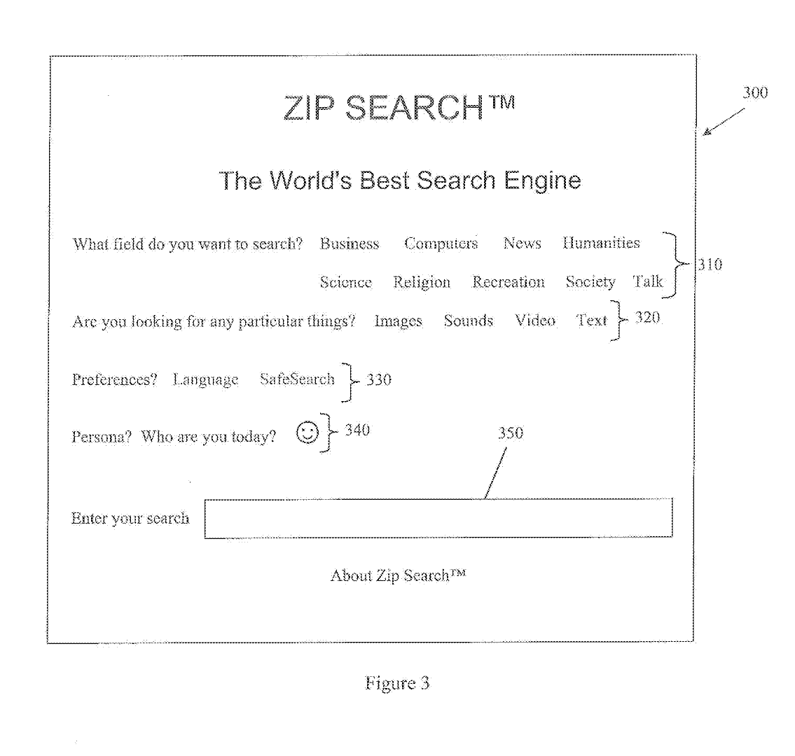

FIG. 3 depicts a hypothetical Zip Search™ interface 300, in a possible configuration that provides a link to a third party provider of persona searching 310. Such a link could, for example, direct a user to an interface such as that depicted in FIGS. 2A, 2B. Significantly, in this Figure the hypothetical search engine also includes selections 320 that limit the source record set by topic, i.e. business, computers, news, humanities, science, religion, recreation, society, and talk. In addition there are other content-based record set limiters for type of information 330 (images, sounds, video, text), and miscellaneous preferences 340 (language and safe search to avoid adult materials). Naturally, there is also a field to enter the search string 350.

Automatically Enhanced Searching

Independent of persona searching, it is also contemplated that one can advantageously enhance search strings to cast a wider net.

Some forms of automated enhanced searching are already in fairly common usage. For example, several search engines automatically expand search terms by number, to include their regular plurals. Thus, a search for “desk AND lamp” will be expanded as “(desk or desks) AND (lamp or lamps). More sophisticated versions of number expansion will expand using regular plurals, such as “women” when one is searching for “woman.” Another relatively common expansion is by synonym. Thus, a search for “elephant” will automatically be expanded to “elephant or pachyderm”. Still another relatively common expansion is by generality. In that case a search for “elephant” will automatically can be expanded to “elephant OR mammal.”

Enhanced searching does not always mean that the search string is physically expanded. It is possible, for example, for an enhanced search string to actually he shorter than the un-enhanced string. Thus, “‘ball valve’ OR ‘needle valve’ OR ‘pinch valve’ OR ‘blow off valve’ OR ‘H valve’ OR ‘linear valve’ OR ‘mushroom valve’ OR ‘control valve’ OR ‘diaphragm valve’ OR mitral valve’ OR ‘bicuspid valve’ OR shuttlecock valve’ OR ‘butterfly valve’ OR ‘bleed valve’ OR ‘blow valve’ OR ‘rectifying valve’” etc might well be expanded to simply “valve OR throttle OR reducer”. Similarly, an enhanced search string need not always include all of the search terms in the string from which it was derived. Indeed, it is possible for an enhanced search string to contain none of the search terms from the parent string.

One very sophisticated type of enhanced searching is semantic enhanced searching. There, terms in a search string are analyzed conceptually to provide a list of alternative terms that convey a similar concept. Thus, a search for “tree” can be conceptually expanded to include “timberline OR woody OR branches.” This requires some sort of database that links words to one another conceptually, and such databases are already known. Hierarchical knowledge systems currently accessible through the Internet include a business-related system at http:://ww.beepknowledgesystem.org/Map.asp and a medical-related system at http://www.skolar.com/. Indeed a reverse-dictionary (such as can be found at http:/www. onelook.com/reverse-dictionary.shtml) is a simple example of a knowledge system, although there the system is relatively flat as opposed to being hierarchical.

Now it is true that a reverse dictionary may well provide words that fall into one of the other categories of number expansion, synonym expansion, or generality expansion. Therefore, to keep these concepts distinct for the purposes of this application, the term semantic enhanced searching is defined as expanding a search string to include at least one term that is not merely number expansion, synonym expansion, or generality expansion. The following table is presented by way of clarification of these distinctions.

| Basic | Number | Synonym | Generality | Conceptual |
|---|---|---|---|---|
| Term | Expansion | Expansion | Expansion | Expansion |
| book | books | folio | dictionary, | leaf, index, sheet, |
| | | | journal, ledger, | print, signature, |
| | | | script, directory, | bind |
| | | | manuscript, | |
| | | | thesaurus, bible, | |
| | | | atlas, volume | |
| elephant | elephants | | loxodonta | tusk, ivory, |
| | | | africana, | trumpet, ear, |
| | | | mastodon, | must, rogue, |
| | | | mammoth, | jumbo |
| | | | pachyderm, | |
| | | | mammal, | |
| | | | vertebrate | |
| walk | walks | | tread, march, | cane, gait, foot, |
| (verb) | | | shuffle, stride, | relaxation, bliss, |
| | | | stumble, waddle, | doddering |
| | | | amble, tiptoe, | |
| | | | plod, shamble, | |
| | | | move | |

In the first row, the plural of book is books. A folio is another name for a book. Dictionary, journal, ledger, script, directory, manuscript, thesaurus, bible, and atlas are all types of books, and a book is a type of volume. The terms leaf, index, sheet, print, signature, and bind are all related concepts, but are not plurals of the term book, are not synonymous with book, are neither types of books or visa versa. In the second row the plural of elephant is elephants. Loxodonta africana, mastodon, and mammoth are all types of elephants, and elephants are types of pachyderms, mammals, and vertebrates. The terms tusk, ivory, trumpet, ear, must, rogue, and jumbo are all related concepts, but are not plurals of the term elephant are not synonymous with elephant, and are neither types of books or visa versa. In the third row, the singular of walk is walks. There are no synonyms per se, but treading, marching, shuffling, striding, stumbling, waddling, ambling, tiptoeing, plodding, and shambling are all forms of walking, and walking is a form of moving. The terms cane, gait, foot, relaxation, bliss and doddering are all related concepts, but are not plurals of the term walk, are not synonymous with walk, and are neither forms of walking or visa versa.

As mentioned above, enhanced searching can be performed independently of persona searching, and vice versa. However, it is specifically contemplated herein to provide systems and methods in which enhanced searching (whether semantic or any other type) is combined with persona searching. This can be accomplished in many ways, including expanding the search string, receiving a results set, and then resorting the results set according to persona characteristics. An alternative is to derive additional search terms from the persona characteristics, and add those search terms to the expanded search terms injunctively (i.e. by using AND connectors rather than the disjunctive OR connectors). The following table provides examples.

| Basic Term | Persona | Semantic Expanded Search String Limited By Persona |
|---|---|---|
| tobacco | purchaser; Zip | (tobacco* OR cigarette* OR cigar*) AND (drugstore* OR |
| | Code = 90010 | store* OR shop*) AND 90010 |
| tobacco | physician | (tobacco* OR cigarette* OR cigar*) AND (cancer OR “lung |
| | | disease” OR “heart disease” OR “clogged arteries” OR |
| | | emphysema) AND (treat* OR therap* OR cure) |
| tobacco | mother | (tobacco* OR cigarette* OR cigar*) AND (cancer OR “lung |
| | | disease” OR “heart disease” OR “clogged arteries” OR |
| | | emphysema) AND (“second hand smoke” OR child OR |
| | | children OR school OR start* OR teach OR train OR |
| | | prevent*) |
| tobacco | farmer | tobacco AND (“crop rotation” OR “nitrogen management” |
| | | OR “plant spacing” OR “varieties” OR mold OR “black |
| | | shank” OR “brown spot” OR “fusarium wilt” OR “soreshin” |
| | | OR “target spot” OR “angular leafspot” OR wilt OR “hollow |
| | | stalk” OR virus OP TEV OR “potato virus y” OR PVY) |
| tobacco | historian | (tobacco OR smoking OR cigarette OR pipe OR cigar) |
| | | AND (history OR begin* OR origin) |

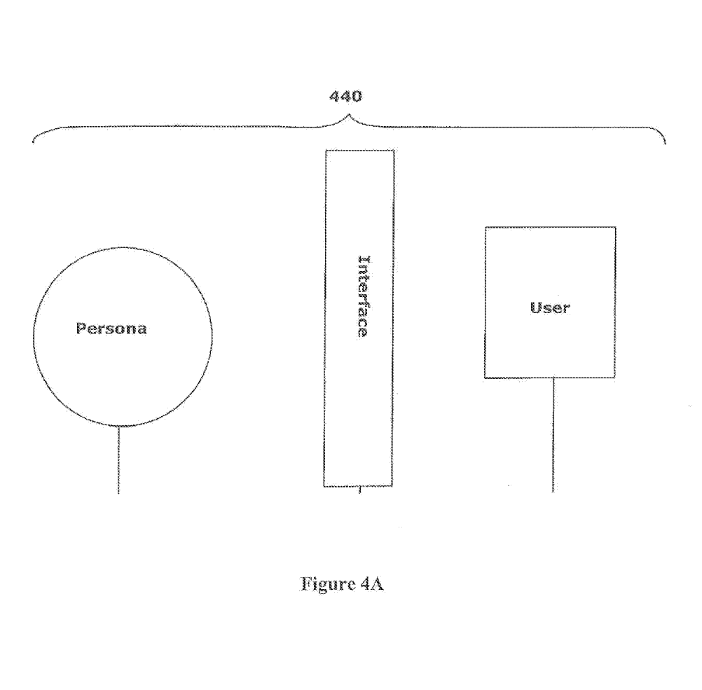

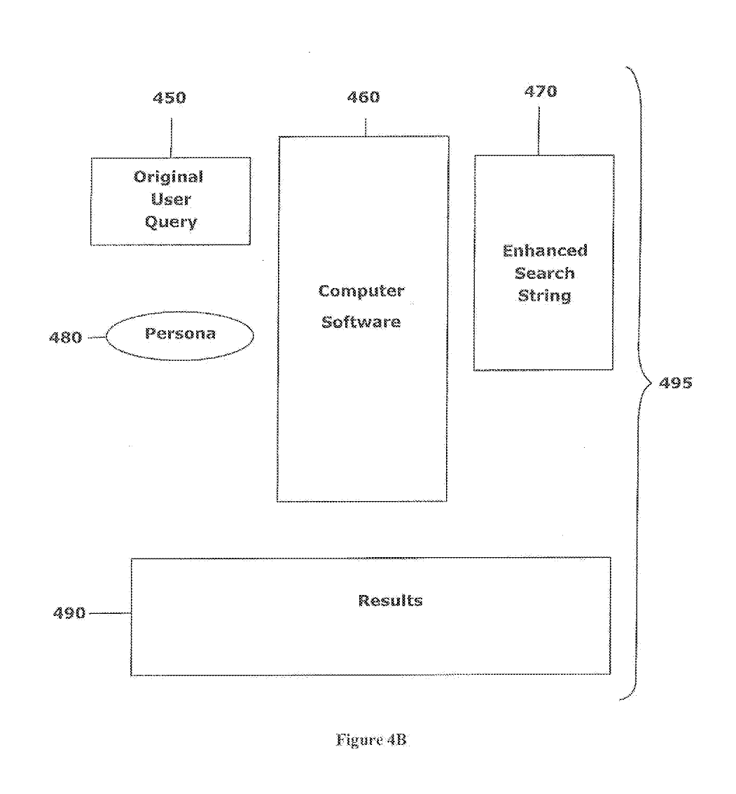

In FIG. 4A depicts that a user can manage a persona through an interface.

FIG. 4B shows the main components involved in enhancing a query and providing results. Computer software take's a user query and a persona, and creates an enhanced search string based on information from the persona. The user then receives search results based on that enhanced search string.

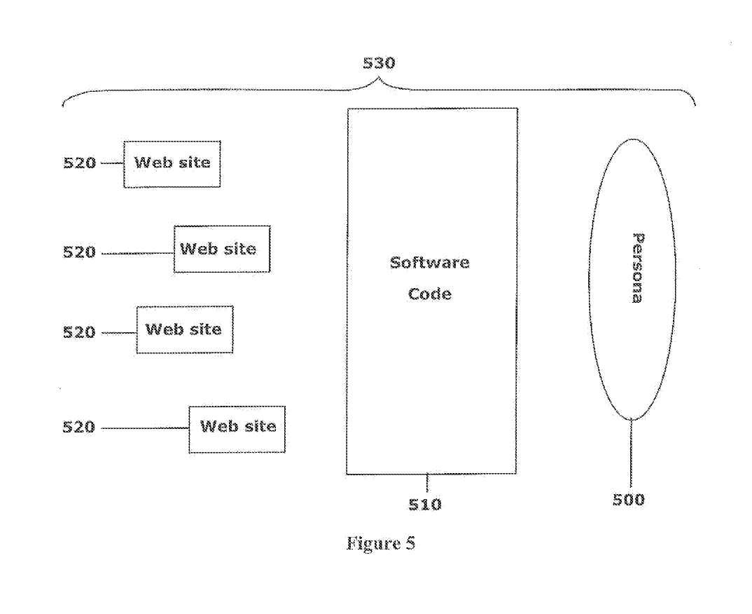

FIG. 5 illustrates that through the software code, a persona can be applied across one or multiple Web sites.

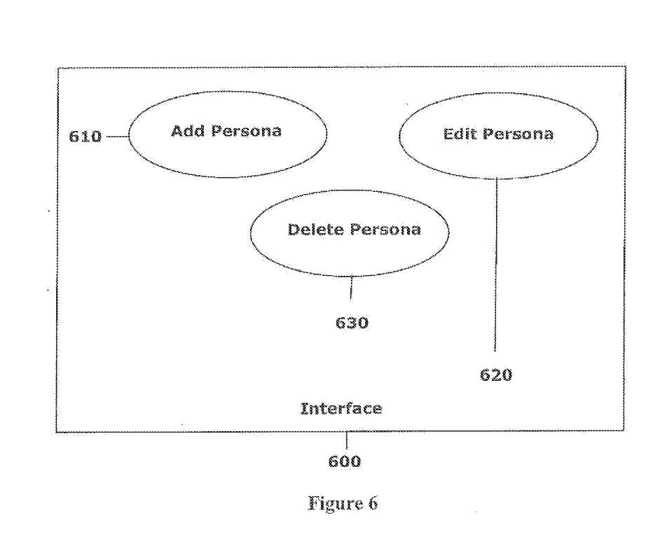

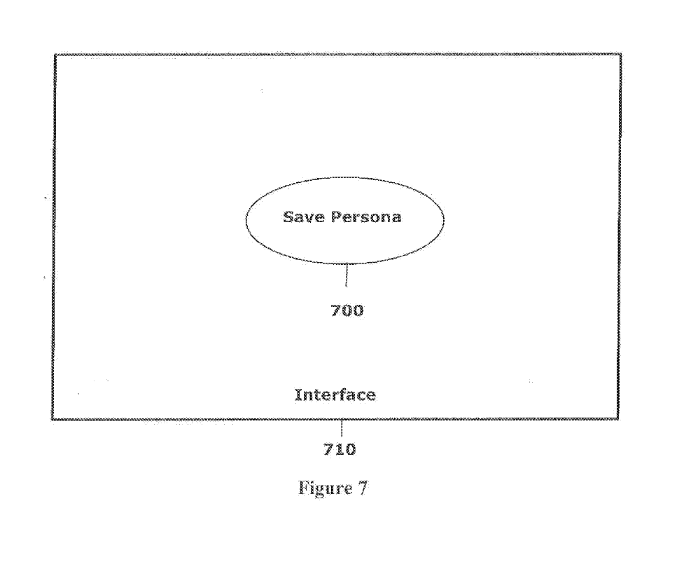

FIG. 6 shows that through the interface a user can add, edit or delete a persona. FIG. 7 illustrates that through the interface a user can save a persona.

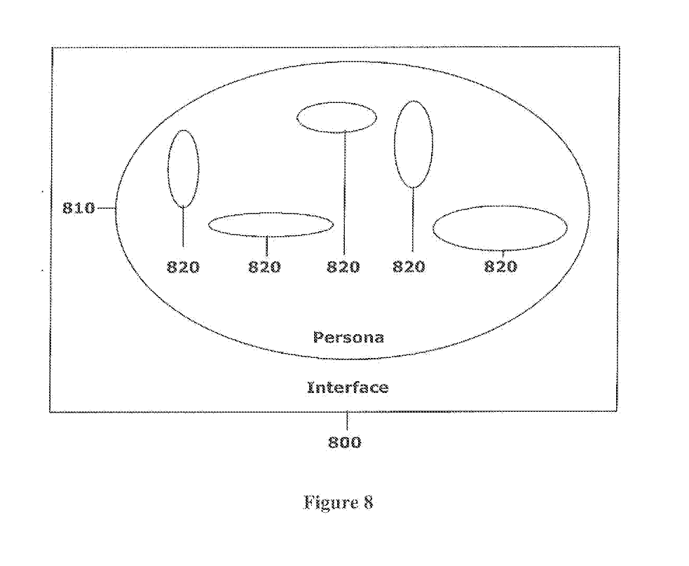

FIG. 8 is a diagram of the interface through which a user can edit the characteristics of a persona. A user has full access to all of the attributes and characteristics of their personas.

The system can analyze the totality of persona attributes and characteristics, in whole of sub-sets, including categorizing by user or other values. It can use this aggregate data to derive new data.

The software runs at least in part on a computer that is operated by a person or organization other than a search engine. The system also runs on at least two different computers.

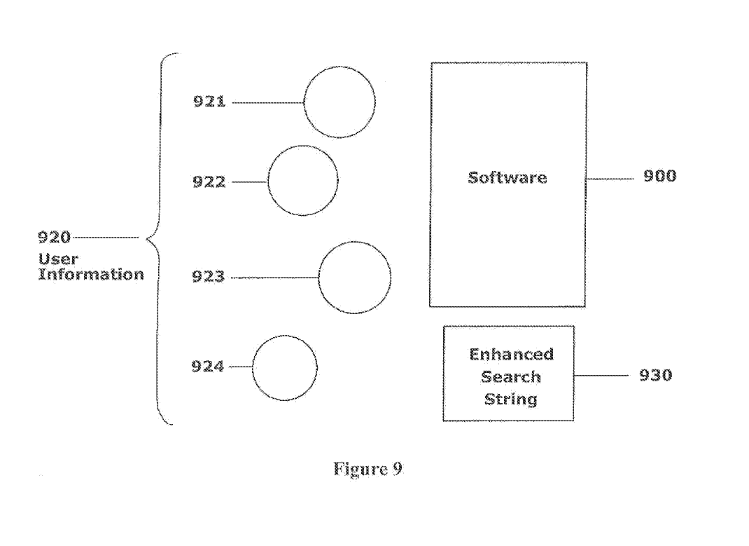

FIG. 9 is a diagram that shows that the software code uses knowledge about a user to create the enhanced search string. The additional knowledge is used to enhance the search string conceptually.

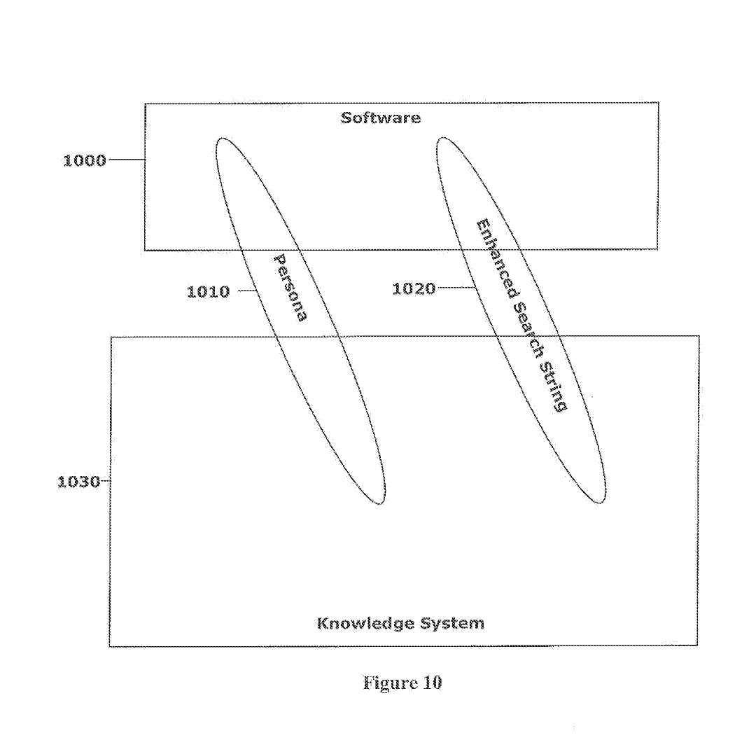

FIG. 10 is a diagram that illustrates, that the software uses a knowledge system to enhance personas and to enhance search strings.

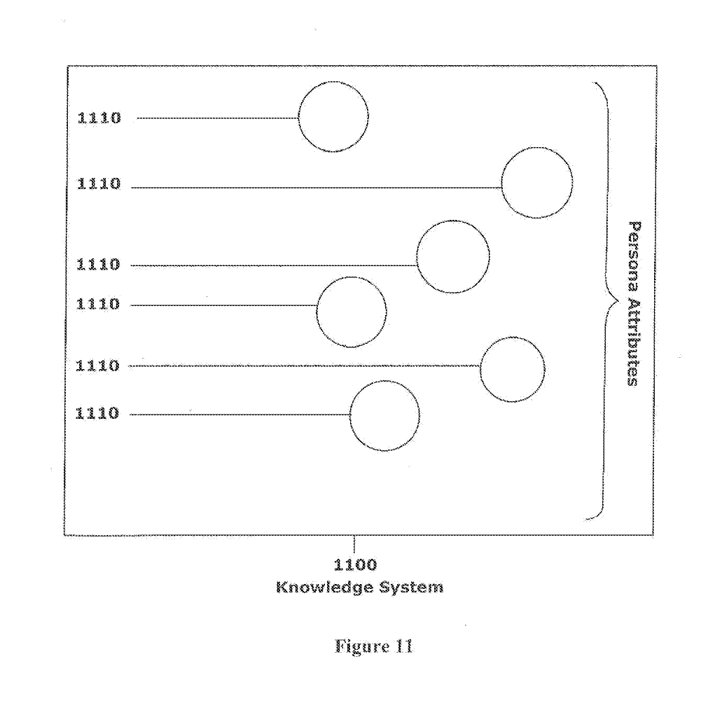

FIG. 11 is a diagram of this knowledge system, which is made up of persona attributes (1110). These attributes are interrelated and have underlying concepts and components. The persona attributes, their interconnections, and their underlying concepts and definitions, comprise the knowledge system.

Although it is contemplated that a separate persona company can be operated to collect and provide persona information to the search engines, the inventors have appreciated that it is those search engines that will always be providing the result set to the end user. It just isn't practical for the search engine to provide the entire result set (of perhaps millions of links) to the persona company, and then have the persona company revise and re-sort that set prior to passing along to the end user. Thus, the key functions of the persona company will be to provide persona information to the search engines, and to provide the search engines with additional information that they can use to implement the persona information.

Two critical aspects to implementing the persona information are (a) assisting the search engine to limit the result set and (b) assisting the search engine to sort the result set. At the present stage of development, the inventors contemplate satisfying the first aspect by improving the search string, and satisfying the second aspect by providing search engine with popularity information. Both of those are in turn can be satisfied by combining persona identification (discussed in earlier applications) and collecting and providing like/dislike information.

It is already known to collect like/dislike information by running a program on each user's computer. For a given website, many developers include a “rate this site” questionnaire for completion by the user. But those questionnaires are site specific. The previously known methods for collecting data on all sites visited by a user are all indirect, such as by silently observing how much time, keystrokes, or some other indicia the user employs with respect to each web page. Those previously known methods are all unsatisfactory because the indirect criteria can, and often do, correlate poorly with actual user preferences.

We contemplate a direct approach in which the user agrees to include an icon on his/her display screen, with which the user can rate websites that he/she is viewing. To enhance user acceptance, we contemplate a simple like/don't like choice, although it is also possible to have a more complicate rating/scoring scheme with more alternatives. The persona company, or perhaps another entity, can then collect the like dislike information, and correlate those preferences with the persona adopted by the user at the time. The persona company would then store preferences for all web sites for which it has data.

The concept can be implemented in many ways. For example, an icon could display a good/bad or like/dislike slider. The icon could easily be a service located in the tray of the display, and could be engaged or disengaged at will by the user. It is further contemplated that the functionality would very likely have logic that prevents or at least inhibits a given user from voting on the same web page more than once. Of course, an icon per se is not necessary. The concept here is to have some sort of functionality that collects like/dislike (or more generally, preference) information. The term “icon” is thus employed euphemistically herein to refer to any visible representation of that functionality.

Assisting The Search Engine To Limit The Remit Set

Search engines already receive a search string from the user. Since most users are inept at employing Boolean logic, most of those search strings are far too simplistic, and result in an exceedingly over-inclusive result set.

However, with the persona preferences in hand, the persona company can readily modify the result set to target desirable records and/or eliminate undesirable records. This can be accomplished as described above with respect to semantically enhanced searches, but there are other contemplated methods as well. The easiest of these to understand is elimination of undesirable records. That can be accomplished by identifying the web pages that users adopting the given persona have disliked, and then modifying the user's search string with a series of “not” elements, i.e., (not webaddress1 or webaddress2 or webaddress3), etc. The modified search string can then be passed back to the search engine in place of the user's search string. Targeting of desirable search records (other than through semantic enhancement) can be based upon determining common patterns among the liked web pages. For example, one persona, may be a retail shopper. For a user search string of “leather arm chair”, the Persona company may add “and price or cost or only or today”.

Assisting the Search Engine to Sort the Result Set

Search engines already have a ranking for every web page. Some rankings are higher because the search engine received a fee to improve the ranking. Other rankings are higher because the search engine operators know that the sites are very popular, or useful. For example, a search for patents will usually result in a link to the US patent office near the top of the list.

It is contemplated that the Persona company can provide its preference data to the search engines for weighing into their page rankings. Most likely that would involve a bit of re-programming on the part of the search engines, because they would need to provide separate ranking fields for each of or at least many of the personas. With the preference data in hand, it is fairly straightforward for the search engine to sort the results set as they normally do, with the highest ranking pages near the top. The key difference is that the identical results set would very likely be sorted differently for users with different personas.

Of course, results would also vary from search engine to search engine. But each search engine has a self-interest in improving the usefulness of the search results, and would therefore tend to make use of the preference information.

Gamine the System

Another concept is to prevent or at least reduce impact of marketers trying to game the system. Some marketers would presumably try to game the system by running numerous searches through the persona portal, determining what additional limitations are being added to the search strings (e.g. “not sale”, “not buy now”, “not special offer”), and then remove or mask those terms from the search engine's access to their web sites. Alternatively, a marketer could try to game the system by creating a dummy website with key words of interest, but omitting the excluded terms, and then link the dummy site to the real site.

But none of that would work because both search string modification and sort enhancement are dependent upon like/dislike preferences. No matter how the system is gamed, the bottom line is that the system will tend to reject web sites that are disliked by users.

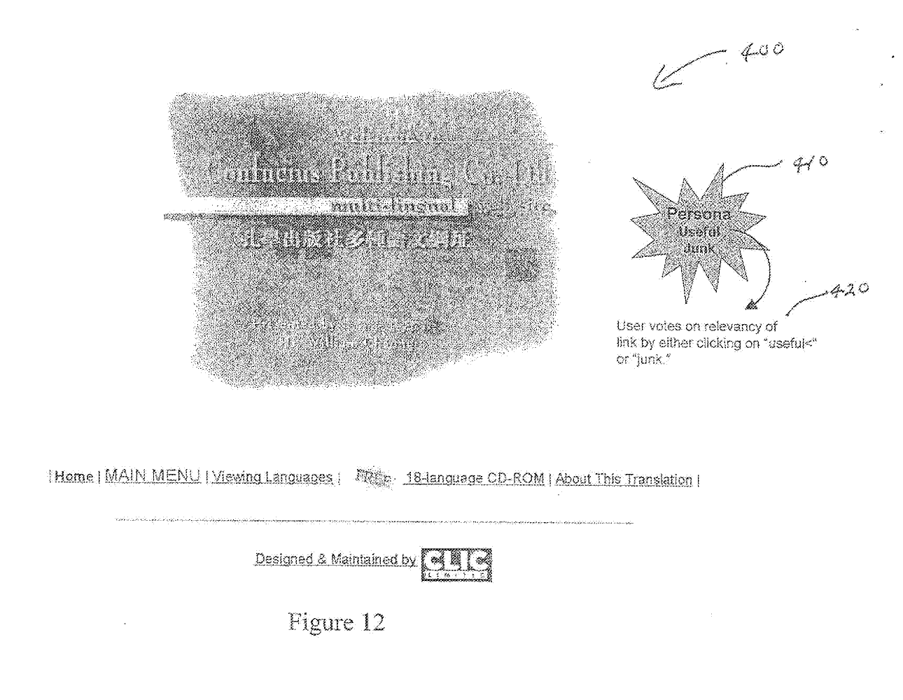

FIG. 12 a web page from a link identified by a search engine to a hypothetical search, showing a like/dislike icon. Here the web page 400 appears on the user's display screen with a like/dislike floater icon 410, and. comments 420 that might be presented to the user when “hovering” over the icon.

Thus, systems and methods for persona based searching have been described. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating, that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A computer-implemented system that maintains an information store of information provided by multiple disparate information providers, and interacts with (a) a user A device operated by an ordinary user A and (b) a user B device operated by an ordinary user B, the system operating software configured to accomplish the following:
cooperate with the user A to create a user A persona that includes a first interest criterion selected from a set of then-available interest criteria;
filter a first item from the information store at least in part according to the first interest criterion, and send the first item to the user A device;
cooperate with the user A to add a second interest criterion to the set of then-available interest criteria to create an updated set of interest criteria;
cooperate with the user B to create a user B persona that includes the second interest criterion selected from the updated set of interest criteria; and
filter a second item from the information store at least in part according to the second interest criterion, and send the second item to the user B device.

2. The system of claim 1 wherein the system is further configured to cooperate with the user A to include demographic characteristics within the user A persona.

3. The system of claim 1 wherein the user A device comprises a user A cell phone, and the system sends the first item to the user A cell phone in response to a user A submitted query.

4. The system of claim 3 wherein the system modifies the user A submitted query by inclusion of the first interest criterion as a search term.

5. The system of claim 3 wherein the system modifies the user A submitted query by inclusion of a search term semantically derived from the first interest criterion.

6. The system of claim 3 wherein the system cooperates with the user B to add a third interest criterion to the user B persona, and to designate relative importance of the second and third interest criteria.

7. The system of claim 1 wherein the system algorithmically modifies the user A persona by analysis of user A behavior.

8. The system of claim 1 wherein the system is further configured to allow user A to rate the first item by providing to the user A device a simple like/dislike icon.

9. The system of claim 1 wherein the system is further configured to select the first item to send to the user A device at least partially as a function of usefulness rankings by other users employing similar personas.

10. The system of claim 1 wherein the system cooperates with the user B to create a second user B persona that is different from the user B persona previously created, and to select which of the user B personas to use at a given time.

11. The system of claim 1 wherein the system cooperates with the user B to create a second user B persona that is inconsistent with the user B persona previously created, and to select which of the user B personas to use at a given time.

12. The system of claim 1 wherein the software uses the second interest criterion to alter content of a user interface on the user B device.
